(19) United States
(12) Patent Application Publication
(10) Pub. No.: US 2025/0378643 A1
(43) Pub. Date: Dec. 11, 2025

(54) MESH GENERATION USING PROMPTS

(71) Applicants: Sergei Korolev, Marina del Rey, CA (US); Mason Liu, Los Angeles, CA (US); Vladislav Shakhrai, Los Angeles, CA (US); Aleksei Stoliar, Marina del Rey, CA (US); Mikhail Vasilkovskii, Playa Vista, CA (US)

(72) Inventors: Sergei Korolev, Marina del Rey, CA (US); Mason Liu, Los Angeles, CA (US); Vladislav Shakhrai, Los Angeles, CA (US); Aleksei Stoliar, Marina del Rey, CA (US); Mikhail Vasilkovskii, Playa Vista, CA (US)

(21) Appl. No.: 18/740,295

(22) Filed: Jun. 11, 2024

(51) Int. Cl. G06T 17/20; G06T 11/00; G06T 13/40; G06V 40/16

(52) U.S. Cl. CPC G06T 17/205; G06T 11/00; G06T 13/40; G06V 40/168; G06V 40/174

(57) ABSTRACT

Described is a system for generating meshes by receiving a prompt from a developer, accessing a default head mesh rigged to facial features of a default head, modifying the default head mesh by inputting the prompt into a stable diffusion model, retrieving gradients from the stable diffusion model, and adjusting a plurality of vertices on the default head mesh according to the gradients, accessing a camera feed from a camera system of a user, the camera feed including a head of the user, and applying a first content augmentation corresponding to the modified head mesh to the head of the user in the camera feed.

### TECHNICAL FIELD

The present disclosure relates generally to mesh generation, and more specifically to mesh generation using prompts.

### BACKGROUND

The popularity of augmented reality operating systems has enabled creation and deployment of augmented reality (AR) applications. AR operating systems combine elements of a traditional operating system with tools and libraries that allow developers to create AR experiences for users. Augmented reality operating systems are an important tool for developers and businesses looking to create compelling AR experiences for their users. They provide a powerful platform for building immersive and interactive applications that can be accessed from a wide range of devices and platforms.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an example flow diagram for generating and applying modified head meshes based on user prompts, according to some examples.

FIG. 5 illustrates an example architecture for generating and applying modified head meshes as content augmentations, according to some examples.

FIG. 6 illustrates a system for 3D mesh generation, in accordance with some examples.

FIG. 7 is a diagrammatic representation of a message, according to some examples.

FIG. 8 illustrates a system including a head-wearable apparatus with a selector input device, according to some examples.

FIG. 9 is a diagrammatic representation of a machine in the form of a computer system within which a set of instructions may be executed to cause the machine to perform any one or more of the methodologies discussed herein, according to some examples.

FIG. 10 is a block diagram showing a software architecture within which examples may be implemented.

FIG. 11 illustrates a machine-learning pipeline, according to some examples.

FIG. 12 illustrates training and use of a machine-learning program, according to some examples.

### DETAILED DESCRIPTION

Traditional systems for generating 3D meshes are technologically disadvantaged in several ways. Traditional methods for creating 3D meshes typically involve manual sculpting and rigging processes, where artists painstakingly manipulate vertices, edges, and faces to create desired shapes and deformations. This manual labor is time-consuming, requires specialized expertise, and may result in inconsistencies or inaccuracies in the final mesh. Moreover, traditional systems may lack automated mechanisms for adjusting meshes based on textual input prompts or dynamically changing facial expressions.

Moreover, traditional systems may struggle to achieve high levels of realism and adaptability in 3D mesh generation. Predefined and static mesh configurations often lack the dynamic range and variability needed to accurately represent real-world objects or respond to user interactions in real-time. As a result, traditional methods may produce static, rigid 3D models that lack the lifelike qualities and responsiveness expected in modern interactive applications, such as augmented reality experiences or virtual avatars.

Furthermore, creating detailed and realistic 3D meshes using traditional methods can be complex and resource-intensive, particularly for large-scale projects or applications requiring a high degree of customization. Traditional workflows may struggle to handle the complexity of generating and manipulating meshes with intricate details or dynamic deformations, leading to scalability challenges and performance limitations, especially in real-time or interactive scenarios.

Traditional 3D mesh generation processes often rely heavily on manual labor and artistic skill, requiring trained artists or designers to manually sculpt, texture, and rig meshes. This dependency on human expertise not only introduces subjectivity and variability into the creation process but also limits the speed and scalability of production. Moreover, traditional workflows may lack support for automated or semi-automated techniques for generating meshes based on abstract textual input or user-defined parameters.

Some embodiments described herein mitigate or eliminate the technological disadvantages of traditional systems. The interaction system revolutionizes the generation of 3D meshes by leveraging image generation models and advanced projection techniques.

The interaction system receives textual prompts describing desired characteristics or features of the 3D mesh. These prompts can be abstract descriptions of shapes, colors, patterns, or even specific objects or scenes.

The interaction system is designed to allow for dynamic adaptation and customization of the 3D mesh based on user interactions or changing input prompts. This enables interactive applications such as augmented reality experiences where users can dynamically modify the appearance of virtual objects in real-time.

Moreover by automating the mesh generation process and leveraging iterative smoothing techniques, the interaction system eliminates the need for manual mesh sculpting and rigging. This not only streamlines the production pipeline but also ensures greater accuracy and consistency in mesh generation, addressing the challenges of traditional methods in achieving lifelike deformations and responsiveness.

The interaction system also enables the generation of highly realistic and adaptable 3D models by combining texture generation with iterative mesh smoothing. The resulting models exhibit lifelike dynamic deformations that respond to user interactions in real-time, surpassing the static and rigid nature of traditional 3D models, the processes of applying rigged default head meshes as further described herein.

With its automated and real-time capabilities, the interaction system offers scalability and efficiency advantages over traditional workflows. The ability to generate and customize 3D meshes and textures dynamically reduces the time and effort required for content creation, making it suitable for large-scale projects and interactive applications.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in a mesh generation process. Computing resources used by one or more machines, databases, or networks may thus be more efficiently utilized or even reduced.

### Networked Computing Environment

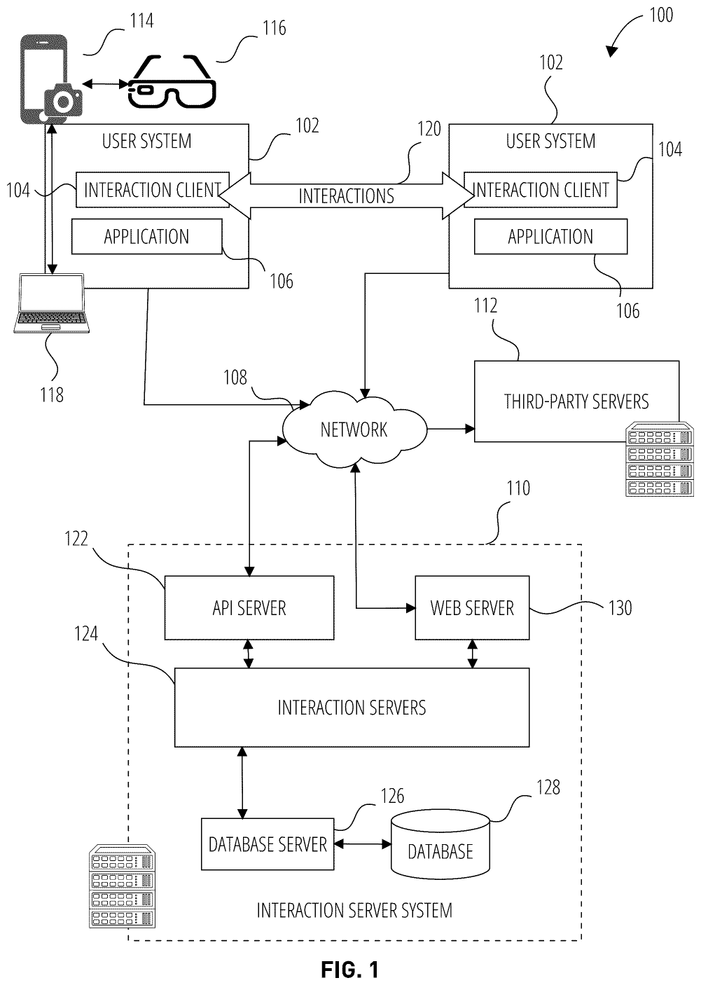

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

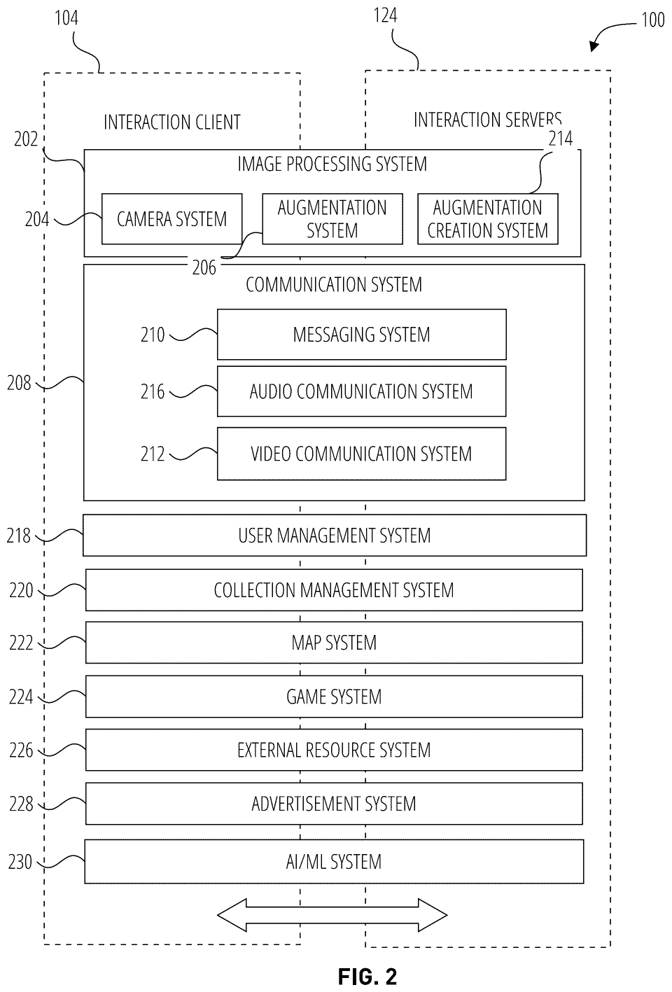

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

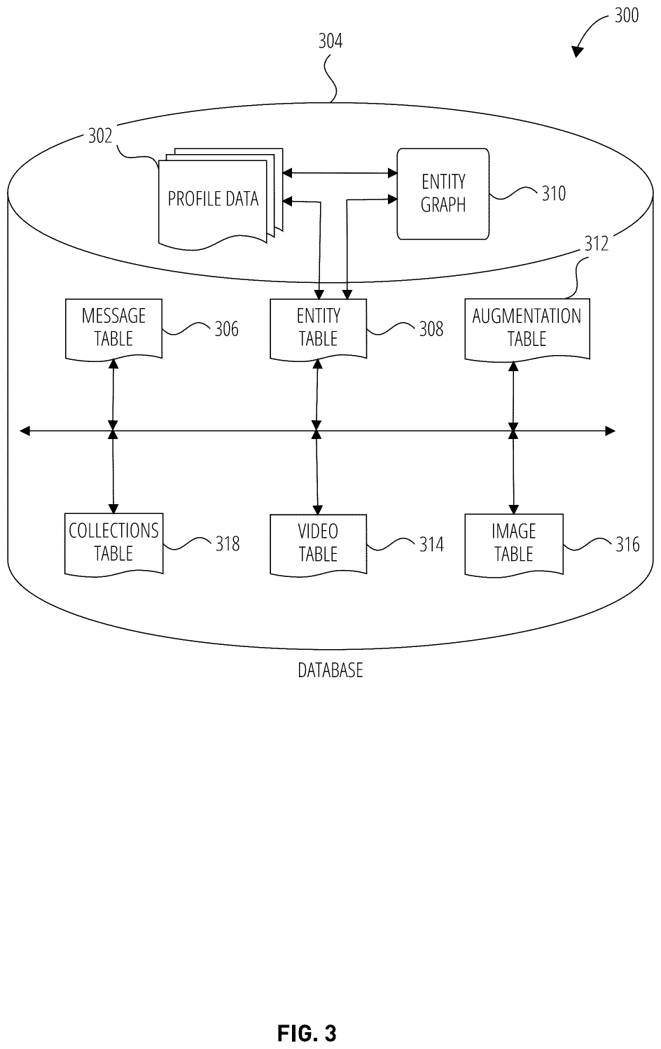

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

### Generating and Applying Modified Head Meshes Based on User Prompts

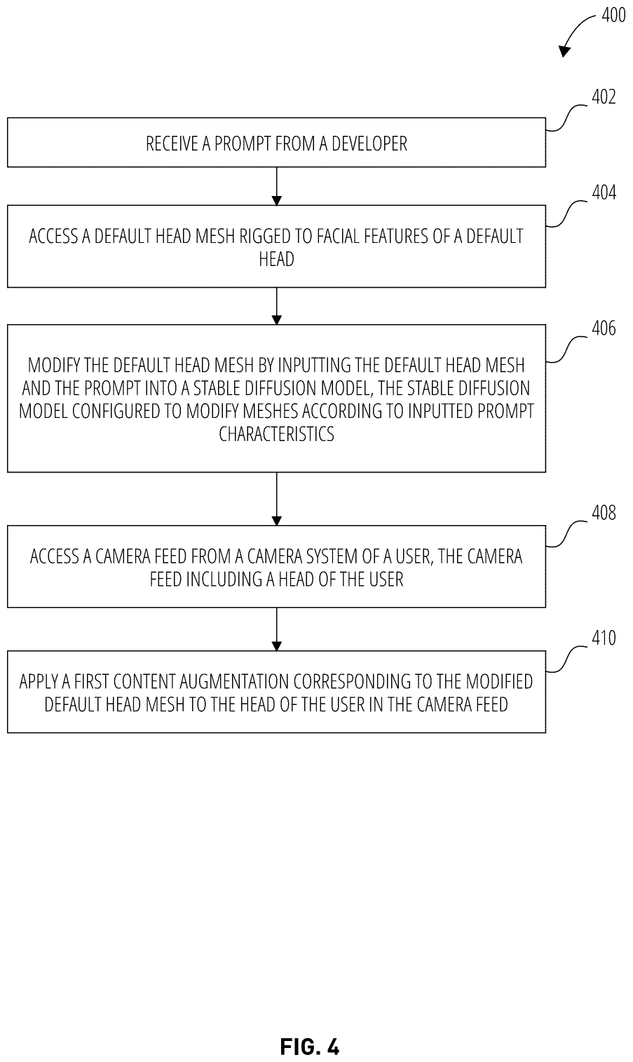

FIG. 4 illustrates an example method 400 for generating and applying modified head meshes based on user prompts, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

FIG. 4 (and other figures herein) is described as being performed by certain systems or applying certain processes, such as a particular machine learning model or computer vision model, but the processes described herein can be performed by one or more other or the same machine learning models, computer vision models, or a combination thereof.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

Embodiments herein are described as being performed by a certain user, such as a user of a device or a developer. However, it is appreciated that features of embodiments can be performed by other users.

Embodiments herein are described as being performed for the generation of meshes, but it is appreciated that such features can also be applied to textures, and vice versa.

At operation 402, the interaction system receives a prompt from a developer. The prompt can be received directly from an input of the developer into a text box. In some cases, identifying the prompt for the developer includes receiving a question or request from the developer via text or speech. The interaction system identifies keywords from the prompt and applies weights to each of the identified keywords. The interaction system applies the identified keywords and corresponding weights to the second machine learning model.

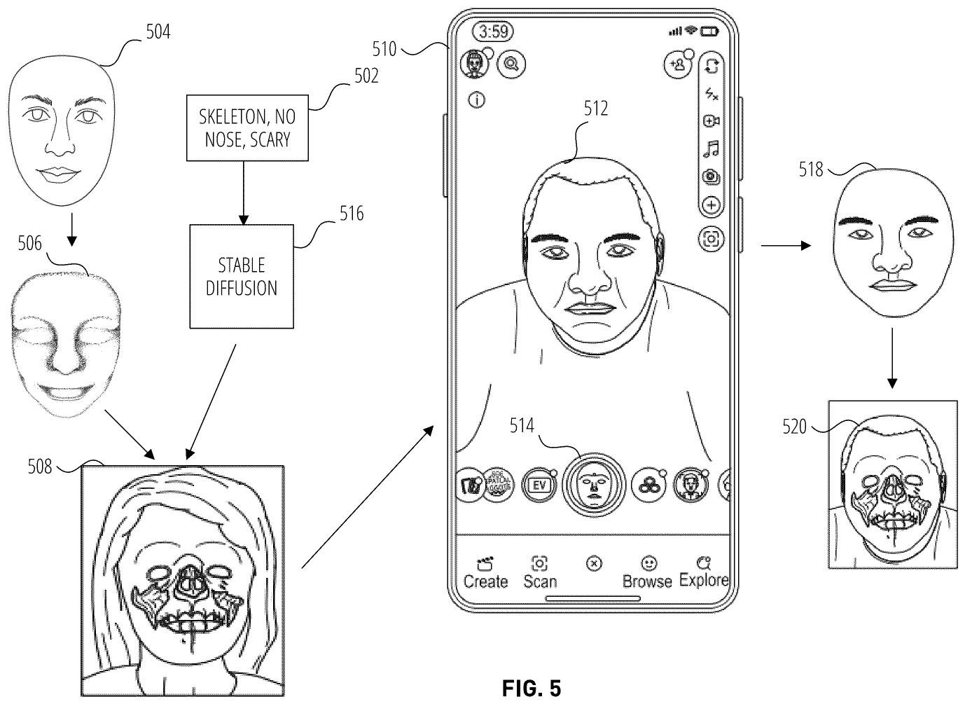

FIG. 5 illustrates an example architecture for generating and applying modified head meshes as content augmentations, according to some examples. In this example, the user inputs “skeleton, no nose, scary” as the user prompt 502.

At operation 404, the interaction system accesses a default head mesh rigged to facial features of a default head. The default head mesh in the context of the interaction system applying 3D modeling and animation is a foundational component used as a starting point for creating meshes in digital environments.

The default head mesh can include a geometric representation of a human head. This geometric representation is composed of vertices, edges, and features that define the surface of the head. These vertices are connected in a specific arrangement to form the shape of the head, including features such as the forehead, nose, eyes, mouth, and chin. The geometry of the default head mesh determines its overall shape and structure.

The topology of the default head mesh includes an arrangement of vertices, edges, and features and how they connect to form the surface of the head. Topology can include animation and/or deformation, and can influences how the mesh can be manipulated without introducing undesirable artifacts like stretching or tearing.

In addition to geometry, the default head mesh may also include texture coordinates. These coordinates define how textures are mapped onto the surface of the mesh. By assigning specific texture coordinates to each vertex of the mesh, textures such as skin tones, hair patterns, and facial features can be accurately applied, enhancing the realism of the model.

The default head mesh is rigged to the facial locations of a default head. As shown in FIG. 5, the default head 504 shows an image of a user's head with eyes, nose, mouth, and eyebrows. The default head mesh 506 includes a mesh representing the default head, where the eyes, nose, mouth, and eyebrows of the default head mesh are in substantially the same location as in the default head.

Rigging in the context of mapping a default head mesh to the facial locations of a head can include associating the vertices of the mesh with specific points on the face. This association allows for the manipulation of the mesh to mimic the movements and expressions of the face.

In some cases, a skeletal structure is used, with bones representing the underlying structure of the character. In some cases for facial rigging, the rigging setup focuses on controlling specific facial features directly. The rigging process can involve defining control points or handles directly on the mesh. These control points can be referred to as joint clusters or control vertices. Each control point corresponds to a specific facial feature or region, such as the mouth, eyes, eyebrows, and jaw.

Once the control points are defined, the interaction system can perform weighting or skinning to assign influence to each control point. This influence can determine how much each control point affects the movement of nearby vertices. For example, the control point associated with the mouth will have a higher influence on the vertices around the mouth area compared to control points further away.

To facilitate weighting, the interaction system can apply vertex groups to organize the vertices of the mesh into regions corresponding to different facial features. Each vertex group is associated with a specific control point or joint cluster. This organization helps in efficiently assigning weights to vertices during the rigging process.

Starting with such a default head mesh that is already rigged to a default head of a user, the interaction system can maintain the rig between the head mesh and the head when changes are made to the mesh, as will be further described herein. As such, once changes to the mesh are made based on prompts and customized to a user's head and expressions, the user can move his or her head with various facial expressions, and the interaction system can apply the modified mesh to create animation that mimics the user's movements.

At operation 406, the interaction system modifies the default head mesh by first inputting the prompt into a stable diffusion model, such as stable diffusion 516 of FIG. 5. The stable diffusion model configured to generate gradients that are used by the interaction system to modify meshes according to inputted prompt characteristics.

For the sake of simplicity, the embodiments described herein are explained in terms of a particular model, such as a stable diffusion model, but it is appreciated that other types of models can be used, such as a diffusion model or image generation model.

The default head mesh serves as the base mesh that will be modified, while the prompt provides specific characteristics or instructions for the modification. The prompt could be textual input describing desired changes to the head mesh, such as altering its shape, features, or expression.

The stable diffusion model is a type of machine learning model and includes a computational model used to generate images. However, the interaction system will instead take the gradients that are generated by the stable diffusion models and modify the default head mesh accordingly.

Gradients represent the rate of change of a function with respect to its inputs. In this context, the stable diffusion model is specifically designed to generate gradients that will be used to guide the modification of the default head mesh.

The gradients produced by the stable diffusion model serve as guidance for how the default head mesh should be altered according to the prompt. These gradients encode information about the desired changes specified in the prompt. For example, if the prompt instructs the system to make the head mesh appear “older,” the gradients will provide direction on how to adjust the vertices of the mesh to achieve this effect, such as adding wrinkles or adjusting facial proportions.

Using the gradients generated by the stable diffusion model, the interaction system modifies the default head mesh accordingly. This modification process involves adjusting the positions of vertices in the mesh based on the information encoded in the gradients. By following the direction provided by the gradients, the system can deform the mesh in a manner consistent with the inputted prompt characteristics.

The interaction system applies core distillation sampling to extract relevant information or features from the stable diffusion model. For modifying a default head mesh using a stable diffusion model, gradients obtained through core distillation sampling play a crucial role for the interaction system to determine how the mesh is modified.

Core distillation sampling involves identifying key elements or “cores” within a dataset that capture essential characteristics or patterns. For modifying the default head mesh, the dataset includes various examples of head meshes and corresponding prompts or instructions for modification. Through core distillation sampling, the stable diffusion model identifies the most relevant features or information from the dataset that are pertinent to the given prompt by analyzing the dataset to extract core elements that best represent the desired modifications specified in the prompt.

Once the relevant features are identified, the stable diffusion model generates gradients based on these core elements. These gradients encode information about how the default head mesh should be modified to align with the characteristics extracted from the dataset. For example, if the prompt calls for making the head mesh appear “younger,” the gradients will reflect the changes needed to achieve this effect, such as smoothing out wrinkles or adjusting facial proportions.

The interaction system applies core distillation sampling to extract essential features or patterns from a dataset. The interaction system specifically applies core distillation on meshes to identify the most critical features needed for the modification process of the mesh.

The interaction system applies a diffusion model, such as a stable diffusion model, that is trained to produce high-quality images from noise. Given a text prompt, the diffusion model generates an image that corresponds to the textual description. These models are trained to generate realistic images based on textual inputs, making them valuable for tasks such as image synthesis and modification.

The interaction system uses such diffusion models not to generate the resulting images, but rather to receive gradients that serve as a guide for modifying meshes based on text prompts. By generating images from noise given a text prompt, the model provides insights into how the mesh should be modified to match the desired characteristics described in the prompt. The generated images offer visual guidance on the desired outcome, helping inform the modification process.

The interaction system receives gradients which include directional derivatives that indicate how a function changes with respect to its inputs. For modifying meshes, the interaction system applies the gradients from the diffusion model to changes in direction and magnitude needed to align the mesh with the desired outcome specified in the text prompt. These gradients guide the modification process by indicating how each vertex of the mesh should be adjusted to achieve the desired modifications.

Once gradients are obtained from the diffusion model, the interaction system moves the vertices of the meshes to align with the rendered mesh. The rendered mesh represents the desired outcome based on the text prompt, while the generated mesh is the initial state of the mesh before modification. By applying the gradients from the model to the generated mesh, the interaction system deforms or adjusts the mesh to match the positions and characteristics of the rendered mesh.

The interaction system applies an SDS (Stable Diffusion Sampling) loss, which includes a loss function that measures the discrepancy between the generated mesh and the rendered mesh. The SDS loss function quantifies how well the modifications align with the desired outcome specified in the text prompt. The interaction system minimizes the SDS loss to ensure that the modified mesh accurately reflects the characteristics described in the prompt, resulting in a realistic and coherent transformation.

The interaction system leverages the stable diffusion model to generate images that guide the modification process by deriving gradients from the model that inform how the mesh should be adjusted to align with the desired outcome, and minimizing SDS Loss that quantifies the fidelity of the modification by measuring the agreement between the generated and rendered meshes.

FIG. 5 illustrates a modified default head mesh 508 that maintains the rigging between the default head mesh with the default head. The interaction system applies the prompt “skeleton, no nose, scary” to a stable diffusion model. Upon receiving the gradients from the model, the interaction system modifies the default head mesh 506 to be a modified default head mesh 508 that better resembles a head corresponding to the descriptors of the prompt. The modified head mesh maintains the rig to the default head, as described above.

Once the modified default head mesh is created, the interaction system creates an application within the platform enabling users to open the application and apply the modified head mesh to the user's face.

Once the developer has created the modified mesh using the described steps above, the interaction system integrates the modified mesh into the platform's infrastructure.

Within the interaction platform's development environment, developers can have access to such tools specifically designed for creating augmented reality (AR) effects. This interface allows developers to define the behavior and appearance of lenses, including the use of custom meshes based on user prompts.

Once the head mesh is generated, the interaction system can apply a texture to the head mesh. The interaction system can apply a texture onto the modified head mesh based on UV mapping where a 2D image is mapped onto a 3D model by unwrapping the 3D model onto a 2D plane creating a UV map.

The interaction system can apply a texture onto the modified head mesh based on procedural texturing using mathematical functions to generate textures dynamically. The interaction system can apply a texture onto the modified head mesh using vertex colors by applying colors directly to the vertices of the mesh. The interaction system can apply a texture onto the modified head mesh using decal texturing by applying decals on top of the base texture. The interaction system can apply the texture using other methods for the application of the texture.

At operation 408, the interaction system accesses a camera feed from a camera system of a user, the camera feed including a head of the user. The interaction system generates an application that applies AR effects to the platform. After the AR effects are published to the platform, users can access the AR effects by selecting an option that applies the modified mesh to a camera feed.

As shown in FIG. 5, a user 512 on a user device 510 selects the AR application 514 of the developer. A camera feed from the user device, such as a mobile device, is assessed and the modified head mesh is applied.

At operation 410, the interaction system applies a first content augmentation corresponding to the modified head mesh to the head of the user in the camera feed. Users can find the AR application by scrolling through a list of applications. Once the user selects the application, the interaction system accesses a camera feed from the user device and applies the modified head mesh onto the head of the user.

The modified default head mesh 508 is not specifically modified to a particular individual's head yet. The modified default head mesh is only modified to correspond with the text prompt. Once a user opens the application, the mobile phone of the user captures a camera feed of the user's head.

The interaction system identifies the user's head 518 in the camera feed. The interaction system can perform computer vision techniques or process the camera feed through a machine learning model that is trained to customize the modified default head mesh to the individual's facial features. As such, the default head mesh can be modified to be a customized head mesh 520 that corresponds with the original text of the developer as well as being modified for the user's head. The customized head mesh is now rigged to the user's head, maintaining the rig from the facial positions of the default head mesh. As such, when the user moves around the camera feed or changes his or her expression, the interaction system can create animations that mimic the movement using the customized head mesh.

The interaction system can identify facial features from a camera feed by applying one or more computer vision techniques or machine learning models. The interaction system can apply face detection algorithms that analyze the pixels in the image to locate regions that likely contain faces. For example, the interaction system can apply facial detection where features such as color, texture, and shape are extracted. The machine learning algorithm analyzes the pixels in the image to identify regions that exhibit these characteristic features, which are likely to contain faces.

After detecting facial landmarks, the system extracts relevant features from the face, such as the shape of the eyes, the width of the mouth, the curvature of the eyebrows, etc. These features help characterize the unique facial structure of the individual. To ensure consistency across different faces and poses, the system may perform face alignment and normalization. This involves transforming the detected face region to a standard pose or orientation, such as aligning the eyes horizontally and normalizing the scale and rotation of the face.

After identifying the different locations of such facial features from the camera feed, the interaction system modifies the default head mesh to be a custom head mesh for the individual user. Once the interaction system has identified the locations of facial features in the camera feed, such as the positions of the eyes, nose, mouth, and other landmarks, the interaction system now possesses spatial information crucial for customizing the default head mesh.

The system establishes a correspondence between the detected facial features and corresponding regions on the default head mesh. For instance, the system maps the detected positions of the eyes to the eye regions of the default head mesh, the position of the nose to the nose region, and so forth. This mapping enables the system to accurately target specific areas of the default head mesh for modification.

Using techniques such as blendshapes or deformation fields, the interaction system deforms the default head mesh based on the detected facial features. For example, the system adjusts the weights of predefined blendshapes to match the positions and movements of the user's facial features. This results in the deformation of the default head mesh to resemble the user's facial structure. Alternatively, the system may utilize deformation fields, which are grids of vectors indicating how each point in the default head mesh should move to align with the detected facial features. These vectors are calculated based on the difference between the positions of the features in the camera feed and their corresponding positions on the default head mesh.

To ensure that the modified head mesh accurately reflects the individual user's facial features and expressions, the system performs fine-tuning and optimization techniques for iterative refinement of the deformation process, such as by comparing pre-adjustment meshes with post-adjustment meshes.

The interaction system can also use blendshapes to deform the default head mesh to match the expression of the user. The interaction system stores predefined configurations of a mesh that represent specific facial expressions or deformations. These configurations are created manually or generated algorithmically to capture various states of the mesh, such as smiles, frowns, raised eyebrows, etc.

The interaction system applies blendshapes using control sliders or weights associated with each expression. These sliders control the intensity or magnitude of each blendshape, allowing smooth interpolation between different expressions. The system maps the detected facial features to corresponding control sliders or blendshapes. For example, the position of the user's mouth corners might be mapped to a blendshape representing a smile, while the position of the eyebrows might be mapped to blendshapes representing raised or furrowed brows.

Based on the mapped facial features, the system adjusts the weights of the relevant blendshapes to match the user's facial expression. For example, if the user smiles, the system increases the weight of the smile blendshape, causing the mesh to deform accordingly. This adjustment is typically done through linear interpolation between blendshapes.

The adjusted mesh, deformed according to the user's facial expression, is rendered in real-time over the camera feed. The rendering process may involve techniques like texture mapping, lighting, and shading to ensure the mesh appears realistic and integrates seamlessly with the user's face in the camera feed.

The features of the embodiments described herein are described as being applied to a face. However, it is appreciated that such features can be applied to others, such as other parts of the body, the body, objects such as a chair or house, or the like.

The interaction system displays a selectable user interface element, such as a button, and in response to a user selection of the selectable user interface element, the interaction system captures a picture or video of the camera feed with the applied first content augmentation. The first content augmentation augments, modifies, or overlays content from the camera feed with one or more digital elements, such as a media content item. The media content items can include at least one of: an image, an animation, or audio.

The media content items include:
Content augmentations to enhance images, videos, or other media content items to share with others, such as by adjusting the color or appearance or adding interactive elements such as animations and facial transformations, in real-time.
Emojis that are small images or icons that represent emotions, reactions, or objects.
Stickers are larger images or animations that can be sent in a chat window.
Images or photographs can be sent to other users to share visual information or document a particular event.
Video clips can be used to share recorded content or document a particular event.
Audio messages can be shared to communicate audible communication.
Graphics Interchange Formats (GIFs) are short animations that can be used to add humor or express emotions.

Systems and methods described herein include training a machine learning network, such as training to generate images from text prompts. The machine learning network can be trained to receive as input text prompts indicating a desired image, and the machine learning model is trained to generate such images in very high quality. The machine learning algorithm can be trained using historical information that include historical text prompts and historical images generated from said text prompts.

Training of models, such as artificial intelligence models, is necessarily rooted in computer technology, and improves modeling technology by using training data to train such models and thereafter applying the models to new inputs to make inferences on the new inputs. Here, the new inputs can be a new text prompt that was never seen by the machine learning model. The trained machine learning model can determine the intent of the prompt and generate corresponding images.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new prompt data) and make predictions that the model was trained for based on the weights or scores that were adjusted during training. Such training of the machine learning models described herein reduces false positives and increases the performance of generating images, let alone gradients as described herein.

In some cases, the interaction system can rig a modified mesh to a face at a later stage. For example, the interaction system can use face tracking to detect key facial landmarks on the user's face, such as the eyes, nose, mouth, and chin. The interaction system can create morph targets or blend shapes for the modified mesh that correspond to various facial expressions and movements. These are predefined shapes that the mesh can morph into.

The interaction system can implement real-time face tracking to capture the user's facial positions and movements. The interaction system maps key facial landmarks detected on the user's face to corresponding points on the modified mesh.

The interaction system creates a skeleton for the modified mesh after the mesh has been modified by placing bones or joints at key positions based on the detected facial landmarks. In some cases, the interaction system can bind the vertices of the finalized mesh to the bones, ensuring the mesh deforms correctly when the bones move. The interaction system can apply or integrate blend shapes that correspond to various facial expressions and movements.

In some cases, the interaction system uses the real-time face tracking data to control the rig. The tracked facial positions and movements drive the bones and blend shapes in the rigged mesh. The interaction system can implement predictive modelling to anticipate the user's facial movements. This involves using machine learning models to predict future movements based on current tracking data. The interaction system adjusts the rigged mesh based on predicted movements to reduce lag and ensure smooth transitions. This helps in maintaining a natural appearance even with rapid facial movements.

In some cases the interaction system leverages one or more techniques and technologies to ensure accurate and realistic movement of the 3D mesh with the user's facial expressions. The interaction system can collect a large dataset of facial movements and corresponding 3D mesh deformations, train a machine learning model (e.g., a neural network) on this dataset to learn the mapping between facial movements and mesh deformations, and during real-time use, the system captures the user's facial movements and inputs them into the trained model, which predicts the necessary deformations of the 3D mesh to match these movements. Once trained, the model can provide real-time predictions, making it suitable for interactive applications.

In some cases, the interaction system creates multiple blend shapes for the modified mesh, each representing a specific facial expression or movement (e.g., smiling, frowning, blinking) by developing a control system that interpolates between these blend shapes based on the user's facial movements detected by the tracking system. The interaction system uses the control system to adjust the mesh in real time by blending between the predefined shapes. The interaction system can apply this technique in combination with other rigging methods to enhance realism.

In some cases, the interaction system designs a skeletal structure (rig) for the modified mesh with bones placed at key facial positions (e.g., jaw, cheeks, eyebrows). The interaction system assigns weights to the vertices of the mesh to determine how much each vertex is influenced by the movement of nearby bones, and integrates an animation system that moves the bones based on the user's tracked facial movements. The skeletal animation is computationally efficient and suitable for real-time applications.

In some cases, the interaction system designs the rig based on Facial Action Coding System (FACS) units, which represent fundamental facial movements. The interaction system maps each FACS unit to specific movements of the mesh, either through bones or blend shapes, and uses face tracking to detect FACS units in the user's facial expressions and drive the corresponding mesh deformations.

In some cases, the interaction system applies Surface-Based Rigging (Surface Constraints) by identify key points on the surface of the user's face and corresponding points on the mesh. The interaction system applies surface constraints to ensure these points on the mesh follow the tracked points on the user's face and uses these constraints to drive the deformation of the entire mesh, ensuring it moves consistently with the user's facial movements.

In some cases, the interaction system applies Physics-Based Rigging by implement a physics engine to simulate the skin, muscles, and bones of the face. The interaction system applies dynamic constraints to the mesh that mimic the physical properties of facial tissues and uses real-time face tracking data to drive the physical simulation, ensuring the mesh deforms naturally with the user's movements.

In some cases, the interaction system modifies a part of the face. The interaction system modifies the mesh for specific parts of the face, such as the eyes or mouth, which involves targeted adjustments to the 3D model that focus on enhancing or altering those specific areas. The interaction system can select the vertices, edges, and faces that form the eye region. The interaction system masks the selected area to protect other parts of the mesh from unintended modifications.

In some cases, the interaction system optimizes the model for certain parts of the face by training specialized machine learning models for each facial feature (e.g., eyes, nose, mouth) to achieve higher accuracy and detail. For instance, a dedicated model for the eyes can focus on capturing intricate details such as the iris texture, eyelid movement, and reflections. Similarly, a model for the nose can emphasize the shape, nostril detail, and skin texture. By isolating each feature, these models can be trained on high-resolution data specific to that feature, enabling more precise and realistic modifications.

The interaction system segments the face into different regions and feeds these regions into their respective models. The system can then combines the outputs of these specialized models to create a cohesive 3D mesh. In other cases, the interaction system feeds the entire face mesh and the machine learning model is trained to modify just the portions that it is trained to modify. Additionally, this modular approach facilitates easier updates and improvements to individual parts without retraining the entire model, making the system more flexible and efficient.

In some cases, the interaction system uses facial tracking to detect and analyze the user's facial expressions in real time by identifying key facial landmarks and movements that correspond to different expressions (e.g., smiling, frowning, raising eyebrows). The interaction system can apply an amplification algorithm that exaggerates these detected expressions. The amplification algorithm scales the movement data or blend shape values beyond their normal range. For example, if a smile typically involves a 30% increase in lip curvature, the algorithm could amplify this to 60% or more.

The interaction system can apply the amplified expression data to the rigged 3D head mesh by modifying the positions of vertices or the intensities of blend shapes to reflect the exaggerated expressions. In some cases, the interaction system continuously adjusts the amplification in real time, ensuring that the expressions on the mesh remain responsive to the user's movements while being noticeably amplified.

Overamplifying expressions can make avatars or characters more expressive and engaging, which is particularly useful in applications like gaming, animation, or virtual communication. The level of amplification can be adjusted based on user preferences or specific application needs, providing flexibility in how expressions are displayed.

In some cases, the interaction system captures the user's current facial state using facial tracking by mapping the user's facial features and expressions onto a baseline 3D head mesh that closely matches their appearance. The interaction system generates the target mesh based on the desired prompt using a machine learning model. This target mesh represents the final appearance, incorporating stylistic elements specified in the prompt (e.g., fantastical features, exaggerated attributes).

The interaction system calculates an intermediate morphing path between the initial human state and the final target style by creating a series of transitional states that gradually transform the mesh from the user's current appearance to the desired style.

The interaction system uses interpolation techniques to blend between the initial mesh and the target mesh over time by linearly interpolating vertex positions and blending textures gradually. The transition can be controlled by a morph factor that ranges from 0 (initial state) to 1 (final state).

The interaction system implements the morphing process in real time, updating the mesh as the morph factor progresses, by a time-based function or user input, allowing for smooth and gradual transitions. The interaction system ensures that facial expressions and movements are preserved and correctly applied throughout the morphing process by updating the rig and blend shapes to match the transitioning mesh.

Slow morphing creates a visually striking effect, which can be used in storytelling, gaming, or virtual environments to depict transformations or character evolution. Gradual transitions can engage users by showing a clear progression from their real appearance to the stylized prompt, enhancing immersion and personalization.

3D Mesh Generation from 2D Rendered Image

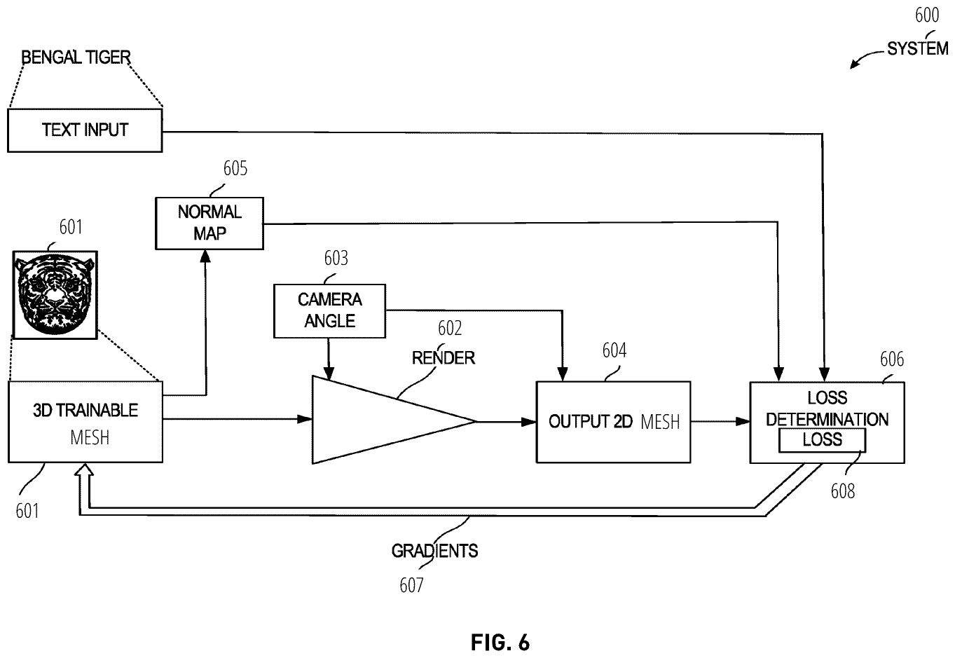

FIG. 6 illustrates a system 600 for 3D mesh generation, in accordance with some examples. The interaction system adjusts the geometry of the 3D trainable mesh 601 by iterating the following operations one or more times. The interaction system renders 602 output 2D mesh 604 from the 3D trainable mesh, a camera angle 603, and, optionally, lighting information. The example 3D trainable mesh 601 is a plain mesh with the Bengal tiger texture. The interaction system determines the normal map 605 from the 3D trainable mesh. The normal map 605 is composed of distances from the surface of the 3D trainable mesh to a normal plain defined by the geometry of the 3D trainable mesh. The interaction system selects different camera angles 603 and/or lighting information during different iterations of training to include a variety of camera angles 603 to train the 3D trainable mesh.

After rendering the output 2D mesh 604, the interaction system determines the gradients 607 based on the loss 608 from a loss determination module 606. The interaction system backpropagates or propagates the gradients 607 to update the geometry of the 3D trainable mesh. The interaction system repeats these operations until the loss 608 transgresses or is below a threshold value, in accordance with some examples. In some examples, the interaction system performs these operations a predetermined number of times. In some examples, the interaction system performs these operations for a fixed amount of time to support a real-time video application that places the 3D trainable mesh on a face of a user.

The interaction system iteratively adjusts the geometry of a 3D trainable mesh based on rendering the mesh as a 2D image, computing loss, determining adjustments, and propagating gradients back to the 3D representation. The interaction system renders the 3D trainable mesh into a 2D image based on a given camera angle and, optionally, lighting information. This involves projecting the 3D geometry onto a 2D plane to create a realistic image of the mesh from the specified viewpoint.

After rendering the 3D mesh into a 2D image, the system computes a loss function that measures the discrepancy between the rendered image and the desired output. This loss function quantifies how well the rendered image matches the target image or desired characteristics, such as fidelity to the original mesh or alignment with the user's facial features.

Using the computed loss, the system determines how the geometry of the 3D trainable mesh should be adjusted to minimize the loss and improve the alignment with the desired output. This adjustment may involve modifying the positions of vertices, adjusting texture mapping, or changing other parameters of the mesh.

The interaction system backpropagates or propagates gradients computed from the loss function to update the geometry of the 3D trainable mesh. Gradients indicate the direction and magnitude of adjustments needed to minimize the loss. By propagating these gradients back to the 3D representation of the mesh, the system can iteratively refine its geometry to better match the desired output.

The interaction system repeats these operations iteratively, adjusting the geometry of the 3D mesh based on the computed gradients and re-rendering it into a 2D image to compute loss. This iterative optimization process continues until the loss converges to a satisfactory level or falls below a predefined threshold. This ensures that the geometry of the 3D mesh progressively improves to better match the desired output or target image.

The interaction system iteratively adjusts the geometry of a 3D trainable mesh based on rendering it into a 2D image, computing loss, determining adjustments, and propagating gradients back to the 3D representation. This iterative optimization process enables the system to refine the geometry of the mesh to better align with the desired output, such as accurately representing facial features in real-time video applications.

### Data Communications Architecture

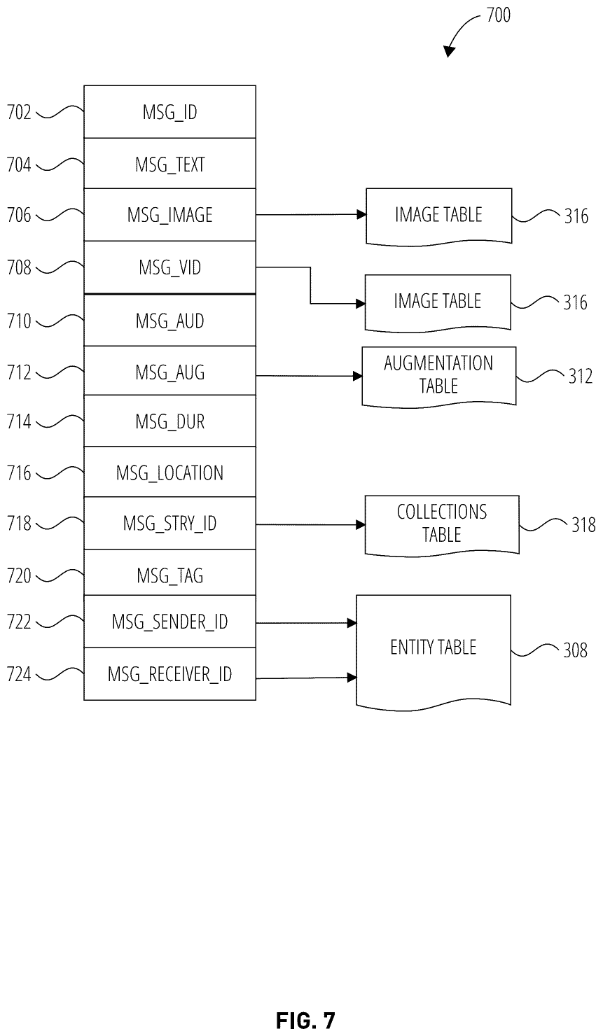

FIG. 7 is a schematic diagram illustrating a structure of a message 700, according to some examples, generated by an interaction client 104 for communication to a further interaction client 104 via the interaction servers 124. The content of a particular message 700 is used to populate the message table 306 stored within the database 304, accessible by the interaction servers 124. Similarly, the content of a message 700 is stored in memory as “in-transit” or “in-flight” data of the user system 102 or the interaction servers 124. A message 700 is shown to include the following example components:
Message identifier 702: a unique identifier that identifies the message 700.
Message text payload 704: text, to be generated by a user via a user interface of the user system 102, and that is included in the message 700.
Message image payload 706: image data, captured by a camera component of a user system 102 or retrieved from a memory component of a user system 102, and that is included in the message 700. Image data for a sent or received message 700 may be stored in the image table 316.
Message video payload 708: video data, captured by a camera component or retrieved from a memory component of the user system 102, and that is included in the message 700. Video data for a sent or received message 700 may be stored in the image table 316.
Message audio payload 710: audio data, captured by a microphone or retrieved from a memory component of the user system 102, and that is included in the message 700.
Message augmentation data 712: augmentation data (e.g., filters, stickers, or other annotations or enhancements) that represents augmentations to be applied to message image payload 706, message video payload 708, or message audio payload 710 of the message 700. Augmentation data for a sent or received message 700 may be stored in the augmentation table 312.
Message duration parameter 714: parameter value indicating, in seconds, the amount of time for which content of the message (e.g., the message image payload 706, message video payload 708, message audio payload 710) is to be presented or made accessible to a user via the interaction client 104.
Message geolocation parameter 716: geolocation data (e.g., latitudinal and longitudinal coordinates) associated with the content payload of the message. Multiple message geolocation parameter 716 values may be included in the payload, each of these parameter values being associated with respect to content items included in the content (e.g., a specific image within the message image payload 706, or a specific video in the message video payload 708).
Message story identifier 718: identifier values identifying one or more content collections (e.g., “stories” identified in the collections table 318) with which a particular content item in the message image payload 706 of the message 700 is associated. For example, multiple images within the message image payload 706 may each be associated with multiple content collections using identifier values.
Message tag 720: each message 700 may be tagged with multiple tags, each of which is indicative of the subject matter of content included in the message payload. For example, where a particular image included in the message image payload 706 depicts an animal (e.g., a lion), a tag value may be included within the message tag 720 that is indicative of the relevant animal. Tag values may be generated manually, based on user input, or may be automatically generated using, for example, image recognition.
Message sender identifier 722: an identifier (e.g., a messaging system identifier, email address, or device identifier) indicative of a user of the user system 102 on which the message 700 was generated and from which the message 700 was sent.
Message receiver identifier 724: an identifier (e.g., a messaging system identifier, email address, or device identifier) indicative of a user of the user system 102 to which the message 700 is addressed.

The contents (e.g., values) of the various components of message 700 may be pointers to locations in tables within which content data values are stored. For example, an image value in the message image payload 706 may be a pointer to (or address of) a location within an image table 316. Similarly, values within the message video payload 708 may point to data stored within an image or video table 316, values stored within the message augmentation data 712 may point to data stored in an augmentation table 312, values stored within the message story identifier 718 may point to data stored in a collections table 318, and values stored within the message sender identifier 722 and the message receiver identifier 724 may point to user records stored within an entity table 308.

System with Head-Wearable Apparatus

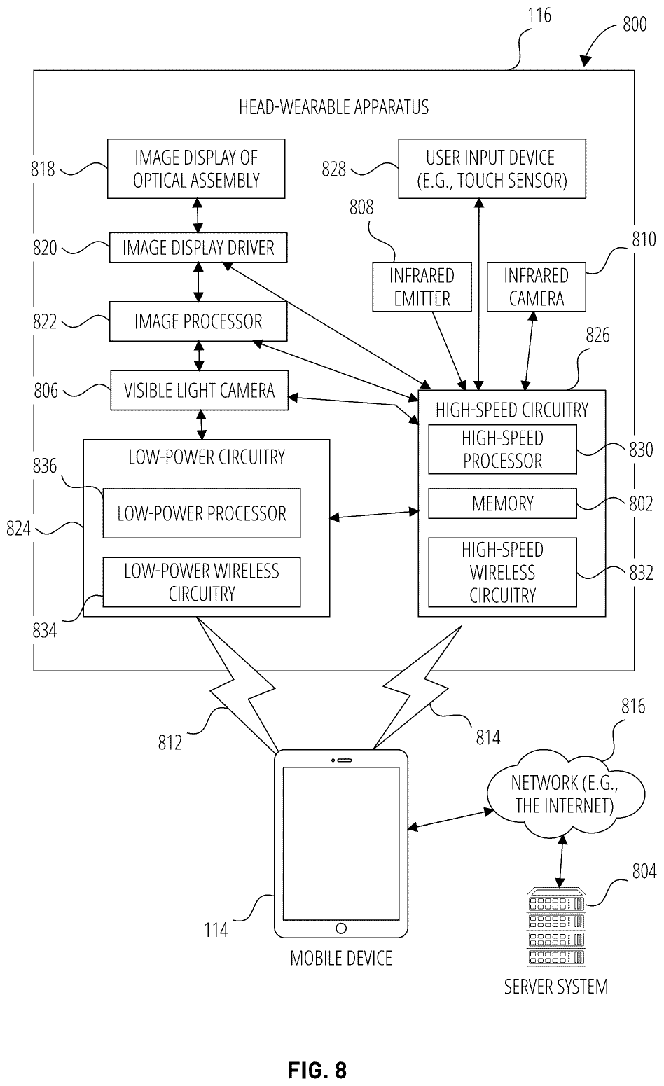

FIG. 8 illustrates a system 800 including a head-wearable apparatus 116 with a selector input device, according to some examples. FIG. 8 is a high-level functional block diagram of an example head-wearable apparatus 116 communicatively coupled to a mobile device 114 and various server systems 804 (e.g., the interaction server system 110) via various networks 108. The networks 108 may include any combination of wired and wireless connections.

The head-wearable apparatus 116 includes one or more cameras, each of which may be, for example, a visible light camera 806, an infrared emitter 808, and an infrared camera 810.

An interaction client, such as a mobile device 114 connects with head-wearable apparatus 116 using both a low-power wireless connection 812 and a high-speed wireless connection 814. The mobile device 114 is also connected to the server system 804 and the network 816.

The head-wearable apparatus 116 further includes two image displays of the image display of optical assembly 818. The two image displays of optical assembly 818 include one associated with the left lateral side and one associated with the right lateral side of the head-wearable apparatus 116. The head-wearable apparatus 116 also includes an image display driver 820, an image processor 822, low-power circuitry 824, and high-speed circuitry 826. The image display of optical assembly 818 is for presenting images and videos, including an image that can include a graphical user interface to a user of the head-wearable apparatus 116.

The image display driver 820 commands and controls the image display of optical assembly 818. The image display driver 820 may deliver image data directly to the image display of optical assembly 818 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 828 (e.g., touch sensor or push button), including an input surface on the head-wearable apparatus 116. The user input device 828 (e.g., touch sensor or push button) is to receive from the user an input selection to manipulate the graphical user interface of the presented image.

The components shown in FIG. 8 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 806 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 802, which stores instructions to perform a subset or all of the functions described herein. The memory 802 can also include storage device.

As shown in FIG. 8, the high-speed circuitry 826 includes a high-speed processor 830, a memory 802, and high-speed wireless circuitry 832. In some examples, the image display driver 820 is coupled to the high-speed circuitry 826 and operated by the high-speed processor 830 in order to drive the left and right image displays of the image display of optical assembly 818. The high-speed processor 830 may be any processor capable of managing high-speed communications and operation of any general computing system needed for the head-wearable apparatus 116. The high-speed processor 830 includes processing resources needed for managing high-speed data transfers on a high-speed wireless connection 814 to a wireless local area network (WLAN) using the high-speed wireless circuitry 832. In certain examples, the high-speed processor 830 executes an operating system such as a LINUX operating system or other such operating system of the head-wearable apparatus 116, and the operating system is stored in the memory 802 for execution. In addition to any other responsibilities, the high-speed processor 830 executing a software architecture for the head-wearable apparatus 116 is used to manage data transfers with high-speed wireless circuitry 832. In certain examples, the high-speed wireless circuitry 832 is configured to implement Institute of Electrical and Electronic Engineers (IEEE) 802.11 communication standards, also referred to herein as WI-FI®. In some examples, other high-speed communications standards may be implemented by the high-speed wireless circuitry 832.

The low-power wireless circuitry 834 and the high-speed wireless circuitry 832 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 812 and the high-speed wireless connection 814, may be implemented using details of the architecture of the head-wearable apparatus 116, as can other elements of the network 816.

The memory 802 includes any storage device capable of storing various data and applications, including, among other things, camera data generated by the left and right visible light cameras 806, the infrared camera 810, and the image processor 822, as well as images generated for display by the image display driver 820 on the image displays of the image display of optical assembly 818. While the memory 802 is shown as integrated with high-speed circuitry 826, in some examples, the memory 802 may be an independent standalone element of the head-wearable apparatus 116. In certain such examples, electrical routing lines may provide a connection through a chip that includes the high-speed processor 830 from the image processor 822 or the low-power processor 836 to the memory 802. In some examples, the high-speed processor 830 may manage addressing of the memory 802 such that the low-power processor 836 will boot the high-speed processor 830 any time that a read or write operation involving memory 802 is needed.

As shown in FIG. 8, the low-power processor 836 or high-speed processor 830 of the head-wearable apparatus 116 can be coupled to the camera (visible light camera 806, infrared emitter 808, or infrared camera 810), the image display driver 820, the user input device 828 (e.g., touch sensor or push button), and the memory 802.

The head-wearable apparatus 116 is connected to a host computer. For example, the head-wearable apparatus 116 is paired with the mobile device 114 via the high-speed wireless connection 814 or connected to the server system 804 via the network 816. The server system 804 may be one or more computing devices as part of a service or network computing system, for example, that includes a processor, a memory, and network communication interface to communicate over the network 816 with the mobile device 114 and the head-wearable apparatus 116.

The mobile device 114 includes a processor and a network communication interface coupled to the processor. The network communication interface allows for communication over the network 816, low-power wireless connection 812, or high-speed wireless connection 814. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 820. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 804, such as the user input device 828, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 812 and high-speed wireless connection 814 from the mobile device 114 via the low-power wireless circuitry 834 or high-speed wireless circuitry 832.

### Machine Architecture

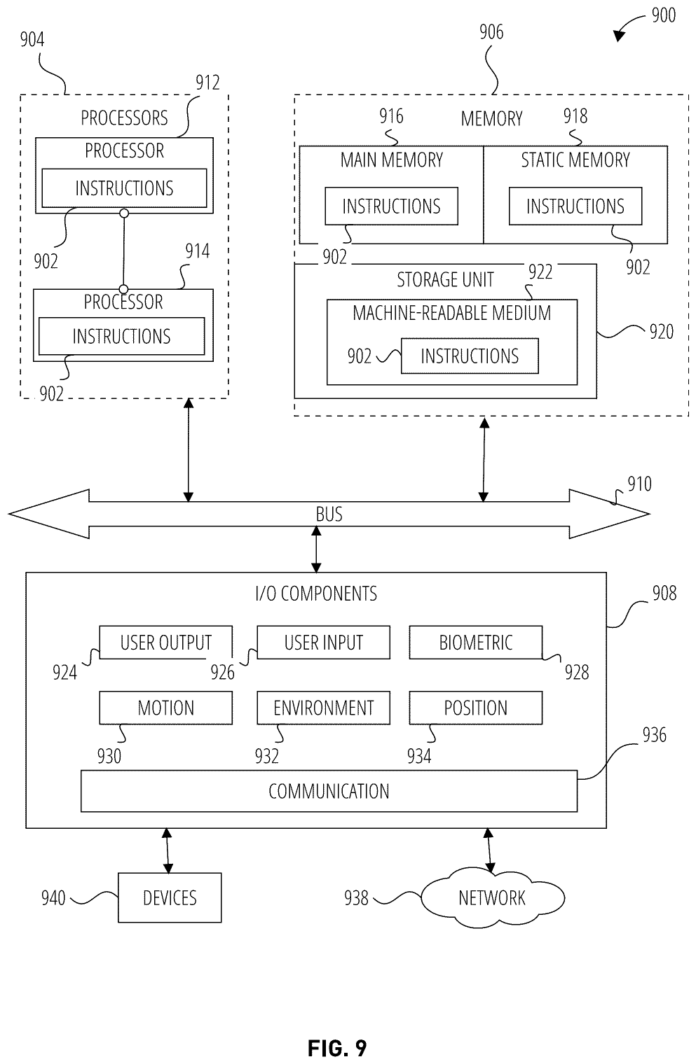

FIG. 9 is a diagrammatic representation of the machine 900 within which instructions 902 (e.g., software, a program, an application, an applet, an app, or other executable code) for causing the machine 900 to perform any one or more of the methodologies discussed herein may be executed. For example, the instructions 902 may cause the machine 900 to execute any one or more of the methods described herein. The instructions 902 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 902, sequentially or otherwise, that specify actions to be taken by the machine 900. Further, while a single machine 900 is illustrated, the term “machine” shall also be taken to include a collection of machines that individually or jointly execute the instructions 902 to perform any one or more of the methodologies discussed herein. The machine 900, for example, may comprise the user system 102 or any one of multiple server devices forming part of the interaction server system 110. In some examples, the machine 900 may also comprise both client and server systems, with certain operations of a particular method or algorithm being performed on the server-side and with certain operations of the particular method or algorithm being performed on the client-side.

The machine 900 may include processors 904, memory 906, and input/output I/O components 908, which may be configured to communicate with each other via a bus 910. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 912 and a processor 914 that execute the instructions 902. The term “processor” is intended to include multi-core processors that may comprise two or more independent processors (sometimes referred to as “cores”) that may execute instructions contemporaneously. Although FIG. 9 shows multiple processors 904, the machine 900 may include a single processor with a single-core, a single processor with multiple cores (e.g., a multi-core processor), multiple processors with a single core, multiple processors with multiples cores, or any combination thereof.

The memory 906 includes a main memory 916, a static memory 918, and a storage unit 920, both accessible to the processors 904 via the bus 910. The main memory 906, the static memory 918, and storage unit 920 store the instructions 902 embodying any one or more of the methodologies or functions described herein. The instructions 902 may also reside, completely or partially, within the main memory 916, within the static memory 918, within machine-readable medium 922 within the storage unit 920, within at least one of the processors 904 (e.g., within the processor's cache memory), or any suitable combination thereof, during execution thereof by the machine 900.

The I/O components 908 may include a wide variety of components to receive input, provide output, produce output, transmit information, exchange information, capture measurements, and so on. The specific I/O components 908 that are included in a particular machine will depend on the type of machine. For example, portable machines such as mobile phones may include a touch input device or other such input mechanisms, while a headless server machine will likely not include such a touch input device. It will be appreciated that the I/O components 908 may include many other components that are not shown in FIG. 9. In various examples, the I/O components 908 may include user output components 924 and user input components 926. The user output components 924 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 926 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 908 may include biometric components 928, motion components 930, environmental components 932, or position components 934, among a wide array of other components. For example, the biometric components 928 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 930 include acceleration sensor components (e.g., accelerometer), gravitation sensor components, rotation sensor components (e.g., gyroscope).

The environmental components 932 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 934 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 908 further include communication components 936 operable to couple the machine 900 to a network 938 or devices 940 via respective coupling or connections. For example, the communication components 936 may include a network interface component or another suitable device to interface with the network 938. In further examples, the communication components 936 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 940 may be another machine or any of a wide variety of peripheral devices (e.g., a peripheral device coupled via a USB).

Moreover, the communication components 936 may detect identifiers or include components operable to detect identifiers. For example, the communication components 936 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 936, such as location via Internet Protocol (IP) geolocation, location via Wi-Fi® signal triangulation, location via detecting an NFC beacon signal that may indicate a particular location, and so forth.

The various memories (e.g., main memory 916, static memory 918, and memory of the processors 904) and storage unit 920 may store one or more sets of instructions and data structures (e.g., software) embodying or used by any one or more of the methodologies or functions described herein. These instructions (e.g., the instructions 902), when executed by processors 904, cause various operations to implement the disclosed examples.

The instructions 902 may be transmitted or received over the network 938, using a transmission medium, via a network interface device (e.g., a network interface component included in the communication components 936) and using any one of several well-known transfer protocols (e.g., hypertext transfer protocol (HTTP)). Similarly, the instructions 902 may be transmitted or received using a transmission medium via a coupling (e.g., a peer-to-peer coupling) to the devices 940.

### Software Architecture

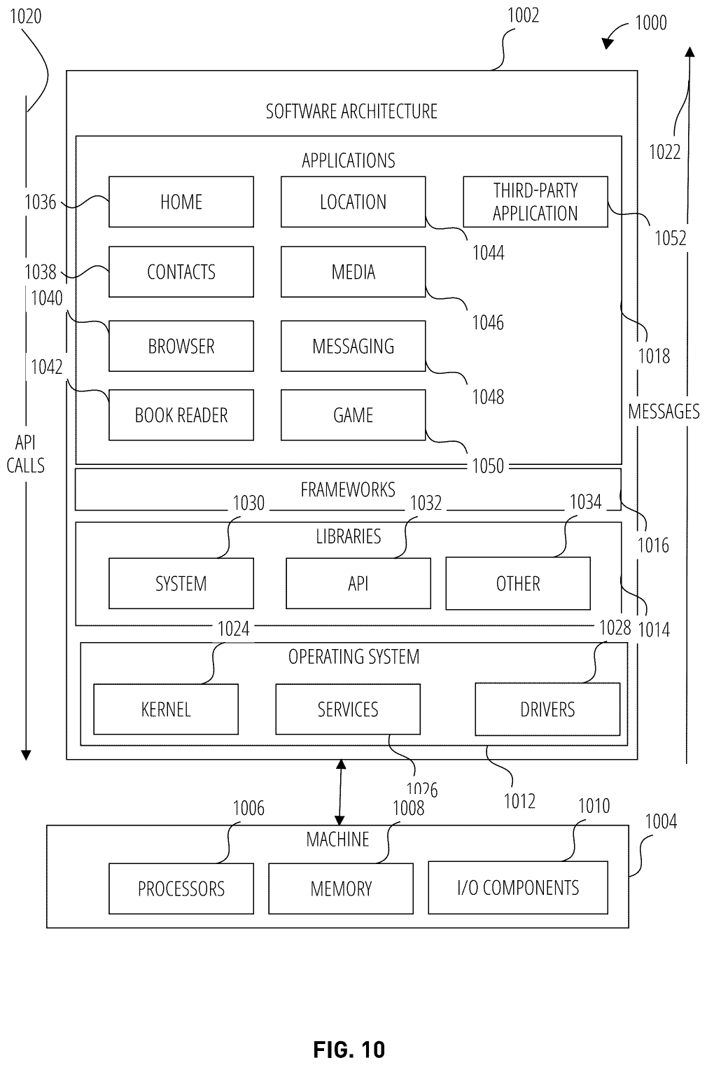

FIG. 10 is a block diagram 1000 illustrating a software architecture 1002, which can be installed on any one or more of the devices described herein. The software architecture 1002 is supported by hardware such as a machine 1004 that includes processors 1006, memory 1008, and I/O components 1010. In this example, the software architecture 1002 can be conceptualized as a stack of layers, where each layer provides a particular functionality. The software architecture 1002 includes layers such as an operating system 1012, libraries 1014, frameworks 1016, and applications 1018. Operationally, the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 provides memory management, processor management (e.g., scheduling), component management, networking, and security settings, among other functionalities. The services 1026 can provide other common services for the other software layers. The drivers 1028 are responsible for controlling or interfacing with the underlying hardware. For instance, the drivers 1028 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1014 provide a common low-level infrastructure used by the applications 1018. The libraries 1014 can include system libraries 1030 (e.g., C standard library) that provide functions such as memory allocation functions, string manipulation functions, mathematic functions, and the like. In addition, the libraries 1014 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1014 can also include a wide variety of other libraries 1034 to provide many other APIs to the applications 1018.

The frameworks 1016 provide a common high-level infrastructure that is used by the applications 1018. For example, the frameworks 1016 provide various graphical user interface (GUI) functions, high-level resource management, and high-level location services. The frameworks 1016 can provide a broad spectrum of other APIs that can be used by the applications 1018, some of which may be specific to a particular operating system or platform.

In an example, the applications 1018 may include a home application 1036, a contacts application 1038, a browser application 1040, a book reader application 1042, a location application 1044, a media application 1046, a messaging application 1048, a game application 1050, and a broad assortment of other applications such as a third-party application 1052. The applications 1018 are programs that execute functions defined in the programs. Various programming languages can be employed to create one or more of the applications 1018, structured in a variety of manners, such as object-oriented programming languages (e.g., Objective-C, Java, or C++) or procedural programming languages (e.g., C or assembly language). In a specific example, the third-party application 1052 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1052 can invoke the API calls 1020 provided by the operating system 1012 to facilitate functionalities described herein.

### Machine-Learning Pipeline

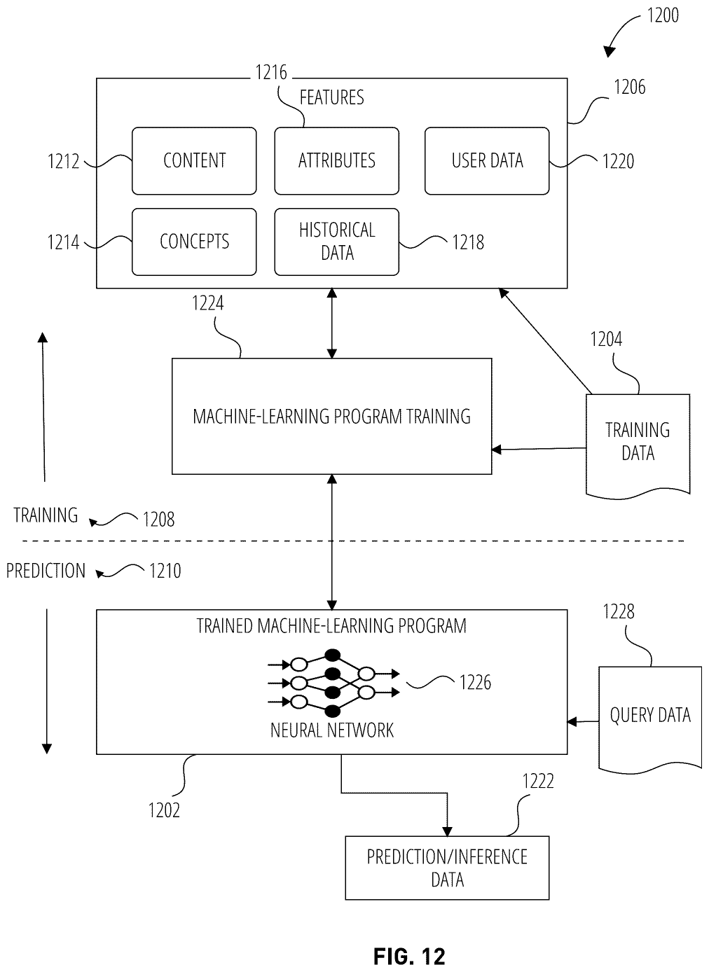

FIG. 12 is a flowchart depicting a machine-learning pipeline 1200, according to some examples. The machine-learning pipelines 1200 may be used to generate a trained model, for example the trained machine-learning program 1202 of FIG. 12, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

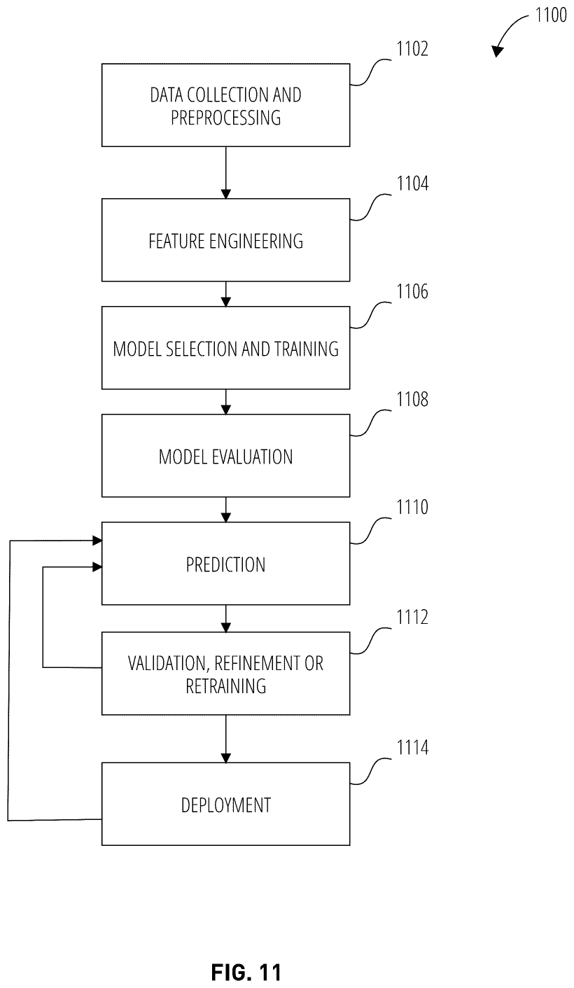

Generating a trained machine-learning program 1202 may include multiple types of phases that form part of the machine-learning pipeline 1200, including for example the following phases 1100 illustrated in FIG. 11:
Data collection and preprocessing 1102: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1104: This may include selecting and transforming the training data 1204 to create features that are useful for predicting the target variable. Feature engineering may include (1) receiving features 1206 (e.g., as structured or labeled data in supervised learning) and/or (2) identifying features 1206 (e.g., unstructured or unlabeled data for unsupervised learning) in training data 1204.
Model selection and training 1106: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1108: This may include evaluating the performance of a trained model (e.g., the trained machine-learning program 1202) on a separate testing dataset. This can help determine if the model is overfitting or underfitting and if it is suitable for deployment.
Prediction 1110: This involves using a trained model (e.g., trained machine-learning program 1202) to generate predictions on new, unseen data.
Validation, refinement or retraining 1112: This may include updating a model based on feedback generated from the prediction phase, such as new data or user feedback.
Deployment 1114: This may include integrating the trained model (e.g., the trained machine-learning program 1202) into a larger system or application, such as a web service, mobile app, or IoT device. This can involve setting up APIs, building a user interface, and ensuring that the model is scalable and can handle large volumes of data.

FIG. 12 illustrates two example phases, namely a training phase 1208 (part of the model selection and trainings 1106) and a prediction phase 1210 (part of prediction 1110). Prior to the training phase 1208, feature engineering 1104 is used to identify features 1206. This may include identifying informative, discriminating, and independent features for the effective operation of the trained machine-learning program 1202 in pattern recognition, classification, and regression. In some examples, the training data 1204 includes labeled data, which is known data for pre-identified features 1206 and one or more outcomes.

Each of the features 1206 may be a variable or attribute, such as individual measurable property of a process, article, system, or phenomenon represented by a data set (e.g., the training data 1204). Features 1206 may also be of different types, such as numeric features, strings, vectors, matrices, encodings, and graphs, and may include one or more of content 1212, concepts 1214, attributes 1216, historical data 1218 and/or user data 1220, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1208, the machine-learning pipeline 1200 uses the training data 1204 to find correlations among the features 1206 that affect a predicted outcome or prediction/inference data 1222.

With the training data 1204 and the identified features 1206, the trained machine-learning program 1202 is trained during the training phase 1208 during machine-learning program training 1224. The machine-learning program training 1224 appraises values of the features 1206 as they correlate to the training data 1204. The result of the training is the trained machine-learning program 1202 (e.g., a trained or learned model).

Further, the training phase 1208 may involve machine learning, in which the training data 1204 is structured (e.g., labeled during preprocessing operations), and the trained machine-learning program 1202 implements a relatively simple neural network 1226 capable of performing, for example, classification and clustering operations. In other examples, the training phase 1208 may involve deep learning, in which the training data 1204 is unstructured, and the trained machine-learning program 1202 implements a deep neural network 1226 that is able to perform both feature extraction and classification/clustering operations.

A neural network 1226 may, in some examples, be generated during the training phase 1208, and implemented within the trained machine-learning program 1202. The neural network 1226 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1226 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1226 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1208, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1226 is iteratively trained by adjusting model parameters to minimize a specific loss function or maximize a certain objective. The system can continue to train the neural network 1226 by adjusting parameters based on the output of the validation, refinement, or retraining block 1112, and rerun the prediction 1110 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1226 even after deployment 1114 of the neural network 1226. The neural network 1226 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1210, the trained machine-learning program 1202 uses the features 1206 for analyzing query data 1228 to generate inferences, outcomes, or predictions, as examples of a prediction/inference data 1222. For example, during prediction phase 1210, the trained machine-learning program 1202 is used to generate an output. Query data 1228 is provided as an input to the trained machine-learning program 1202, and the trained machine-learning program 1202 generates the prediction/inference data 1222 as output, responsive to receipt of the query data 1228. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1202 may be a generative AI model. Generative AI is a term that may refer to any type of artificial intelligence that can create new content from training data 1204. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1222 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a prompt from a developer; accessing a default head mesh rigged to facial features of a default head; modifying the default head mesh by: inputting the prompt into a stable diffusion model; retrieving gradients from the stable diffusion model; and adjusting a plurality of vertices on the default head mesh according to the gradients; accessing a camera feed from a camera system of a user, the camera feed including a head of the user; and applying a first content augmentation corresponding to the modified head mesh to the head of the user in the camera feed.

In Example 2, the subject matter of Example 1 includes, wherein the operations further comprise training the stable diffusion model to generate images based on inputted prompts, wherein during the generation of an image based on the inputted prompt, the stable diffusion model generates the gradients.

In Example 3, the subject matter of Example 2 includes, wherein the gradients including encoded information that includes instructions on changes to the vertices of the default head mesh is to be adjusted to correspond to the inputted prompt.

In Example 4, the subject matter of Examples 2-3 includes, wherein the gradients include individual rates of change for corresponding vertices of the default head mesh.

In Example 5, the subject matter of Examples 1-4 includes, wherein the operations further comprise: comparing the modified default head mesh with a rendered mesh to identify a loss, the rendered mesh representing a desired mesh outcome based on the inputted prompt; and further modifying the modified default head mesh causing a reduction in the loss.

In Example 6, the subject matter of Examples 1-5 includes,) generate the gradients based on the identified relevant features.

In Example 7, the subject matter of Examples 1-6 includes, subsequent to modifying the default head mesh, generating an application configured to be used by a plurality of users to apply the modified head mesh to corresponding users of the system via camera feeds from corresponding user devices; and receiving a selection of the application by the user, wherein accessing the camera feed is in response to receiving the selection of the application.

In Example 8, the subject matter of Examples 1-7 includes, wherein the operations further comprise: assessing the camera feed to identify facial features of the head of the user; identifying locations of the facial features relative to the head; and customizing the default head mesh such that the location of the facial features of the default head mesh correspond to the location of the facial features of the head of the user, the first content augmentation comprising applying the customized head mesh to the head of the user in the camera feed.

In Example 9, the subject matter of Example 8 includes, wherein customizing the default head mesh includes deforming the default head mesh by adjusting weights of predefined blend shapes to match the location of the facial features of the head of the user.

In Example 10, the subject matter of Example 9 includes, wherein the weights are further adjusted to control a magnitude of intensity for a corresponding blend shape.

In Example 11, the subject matter of Examples 9-10 includes, wherein the operations further comprise: assessing the camera feed to identify a facial expression of the head of the user; and further customizing the default head mesh such that the facial expression of the default head mesh corresponds to the facial expression of the head of the user.

In Example 12, the subject matter of Examples 8-11 includes, wherein customizing the default head mesh includes adjusting vectors of the default head mesh, the vectors determined based on a difference between a location of a facial feature in the camera feed to a location of a corresponding facial feature in the default head mesh.

In Example 13, the subject matter of Examples 8-12 includes, D image and an expected image, adjusting the default head mesh based on the computed loss function, and propagating gradients back to the adjusted default head mesh.

In Example 14, the subject matter of Examples 1-13 includes, wherein the operations further comprise: accessing a default body mesh rigged to features of a default body; modifying the default body mesh by: inputting the prompt into a stable diffusion model; retrieving gradients from the stable diffusion model; and adjusting a plurality of vertices on the default body mesh according to the gradients; accessing a camera feed from a camera system of a user, the camera feed including a body of the user; and applying the first content augmentation that also corresponds to the modified body mesh to the body of the user in the camera feed.

In Example 15, the subject matter of Examples 1-14 includes, wherein the operations further comprise: displaying a selectable user interface element; and in response to a user selection of the selectable user interface element, capturing a picture or video of the camera feed with the applied first content augmentation.

In Example 16, the subject matter of Examples 1-15 includes, wherein the first content augmentation augments, modifies, or overlays content from the camera feed with one or more digital elements, wherein one or more digital elements include at least one of: an image, an animation, or audio.

Example 17 is a method comprising: receiving a prompt from a developer; accessing a default head mesh rigged to facial features of a default head; modifying the default head mesh by: inputting the prompt into a stable diffusion model; retrieving gradients from the stable diffusion model; and adjusting a plurality of vertices on the default head mesh according to the gradients; accessing a camera feed from a camera system of a user, the camera feed including a head of the user; and applying a first content augmentation corresponding to the modified head mesh to the head of the user in the camera feed.

In Example 18, the subject matter of Example 17 includes, training the stable diffusion model to generate images based on inputted prompts, wherein during the generation of an image based on the inputted prompt, the stable diffusion model generates the gradients.

In Example 19, the subject matter of Examples 17-18 includes, comparing the modified default head mesh with a rendered mesh to identify a loss, the rendered mesh representing a desired mesh outcome based on the prompt; and further modifying the modified default head mesh causing a reduction in the loss.

Example 20 is a non-transitory computer-readable storage medium storing instructions that, when executed by at least one processor, cause the at least one processor to perform operations comprising: receiving a prompt from a developer; accessing a default head mesh rigged to facial features of a default head; modifying the default head mesh by: inputting the prompt into a stable diffusion model; retrieving gradients from the stable diffusion model; and adjusting a plurality of vertices on the default head mesh according to the gradients; accessing a camera feed from a camera system of a user, the camera feed including a head of the user; and applying a first content augmentation corresponding to the modified head mesh to the head of the user in the camera feed.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a prompt from a developer;
accessing a default head mesh rigged to facial features of a default head;
modifying the default head mesh by:
inputting the prompt into a stable diffusion model;
retrieving gradients from the stable diffusion model; and
adjusting a plurality of vertices on the default head mesh according to the gradients;
accessing a camera feed from a camera system of a user, the camera feed including a head of the user; and
applying a first content augmentation corresponding to the modified head mesh to the head of the user in the camera feed.

2. The system of claim 1, wherein the operations further comprise training the stable diffusion model to generate images based on inputted prompts, wherein during the generation of an image based on the inputted prompt, the stable diffusion model generates the gradients.

3. The system of claim 2, wherein the gradients including encoded information that includes instructions on changes to the vertices of the default head mesh is to be adjusted to correspond to the inputted prompt.

4. The system of claim 2, wherein the gradients include individual rates of change for corresponding vertices of the default head mesh.

5. The system of claim 1, wherein the operations further comprise:
comparing the modified default head mesh with a rendered mesh to identify a loss, the rendered mesh representing a desired mesh outcome based on the inputted prompt; and
further modifying the modified default head mesh causing a reduction in the loss.

6. The system of claim 1, wherein inputting the prompt into the stable diffusion model causes the stable diffusion model to (1) identify relevant features from a dataset of a plurality of head meshes and corresponding prompts and (2) generate the gradients based on the identified relevant features.

7. The system of claim 1, subsequent to modifying the default head mesh, generating an application configured to be used by a plurality of users to apply the modified head mesh to corresponding users of the system via camera feeds from corresponding user devices; and
receiving a selection of the application by the user, wherein accessing the camera feed is in response to receiving the selection of the application.

8. The system of claim 1, wherein the operations further comprise:
assessing the camera feed to identify facial features of the head of the user;
identifying locations of the facial features relative to the head; and
customizing the default head mesh such that the location of the facial features of the default head mesh correspond to the location of the facial features of the head of the user, the first content augmentation comprising applying the customized head mesh to the head of the user in the camera feed.

9. The system of claim 8, wherein customizing the default head mesh includes deforming the default head mesh by adjusting weights of predefined blend shapes to match the location of the facial features of the head of the user.

10. The system of claim 9, wherein the weights are further adjusted to control a magnitude of intensity for a corresponding blend shape.

11. The system of claim 9, wherein the operations further comprise:
assessing the camera feed to identify a facial expression of the head of the user; and
further customizing the default head mesh such that the facial expression of the default head mesh corresponds to the facial expression of the head of the user.

12. The system of claim 8, wherein customizing the default head mesh includes adjusting vectors of the default head mesh, the vectors determined based on a difference between a location of a facial feature in the camera feed to a location of a corresponding facial feature in the default head mesh.

13. The system of claim 8, wherein customizing the default head mesh comprises rendering the default head mesh as a 2D image, computing a loss function that measures a discrepancy between the 2D image and an expected image, adjusting the default head mesh based on the computed loss function, and propagating gradients back to the adjusted default head mesh.

14. The system of claim 1, wherein the operations further comprise:
accessing a default body mesh rigged to features of a default body;
modifying the default body mesh by:
inputting the prompt into a stable diffusion model;
retrieving gradients from the stable diffusion model; and
adjusting a plurality of vertices on the default body mesh according to the gradients;
accessing a camera feed from a camera system of a user, the camera feed including a body of the user; and
applying the first content augmentation that also corresponds to the modified body mesh to the body of the user in the camera feed.

15. The system of claim 1, wherein the operations further comprise:
displaying a selectable user interface element; and
in response to a user selection of the selectable user interface element, capturing a picture or video of the camera feed with the applied first content augmentation.

16. The system of claim 1, wherein the first content augmentation augments, modifies, or overlays content from the camera feed with one or more digital elements, wherein one or more digital elements include at least one of: an image, an animation, or audio.

17. A method comprising:
receiving a prompt from a developer;
accessing a default head mesh rigged to facial features of a default head;
modifying the default head mesh by:
inputting the prompt into a stable diffusion model;
retrieving gradients from the stable diffusion model; and
adjusting a plurality of vertices on the default head mesh according to the gradients;
accessing a camera feed from a camera system of a user, the camera feed including a head of the user; and
applying a first content augmentation corresponding to the modified head mesh to the head of the user in the camera feed.

18. The method of claim 17, further comprising training the stable diffusion model to generate images based on inputted prompts, wherein during the generation of an image based on the inputted prompt, the stable diffusion model generates the gradients.

19. The method of claim 17, further comprising comparing the modified default head mesh with a rendered mesh to identify a loss, the rendered mesh representing a desired mesh outcome based on the prompt; and further modifying the modified default head mesh causing a reduction in the loss.

20. A non-transitory computer-readable storage medium storing instructions that, when executed by at least one processor, cause the at least one processor to perform operations comprising:
receiving a prompt from a developer;
accessing a default head mesh rigged to facial features of a default head;
modifying the default head mesh by:
inputting the prompt into a stable diffusion model;
retrieving gradients from the stable diffusion model; and
adjusting a plurality of vertices on the default head mesh according to the gradients;
accessing a camera feed from a camera system of a user, the camera feed including a head of the user; and
applying a first content augmentation corresponding to the modified head mesh to the head of the user in the camera feed.
